(19) United States
(12) Patent Application Publication
(10) Pub. No.: US 2025/0165363 A1
(43) Pub. Date: May 22, 2025

(54) DIAGNOSIS OF A SHARED BUS USING INDICATORS APPLIED TO A VECTOR BASED ON THE AMPLITUDE OF AN OBSERVED SIGNAL

(71) Applicant: Microchip Technology Incorporated, Chandler, AZ (US)

(72) Inventors: Markus Becht, Marxzell (DE); Werner Weber, Stutensee (DE); Hans-Martin Kaufmann, Remchingen (DE); Jing Richter-Xu, Pforzheim (DE)

(73) Assignee: Microchip Technology Incorporated, Chandler, AZ (US)

(21) Appl. No.: 18/590,213

(22) Filed: Feb. 28, 2024

Related U.S. Application Data
(60) Provisional application No. 63/601,793, filed on Nov. 22, 2023.

(51) Int. Cl. G06F 11/22; G06F 11/277

(52) U.S. Cl. CPC G06F 11/221

(57) ABSTRACT

Systems and methods for diagnosing a shared bus based on an indicator applied to a vector of amplitudes of signals transmitted over the bus. An aspect provides a method comprising: transmitting a pulse signal over a shared bus; capturing an observed signal, wherein the observed signal is a superimposition of the pulse signal and a reflection signal; comparing an amplitude of the observed signal to a plurality of threshold values; creating a vector indicating a given threshold at which the amplitude of the observed signal first exceeds one of the plurality of threshold values at a plurality of sampling times; applying an indicator to the vector; and diagnosing the shared bus based on the indicator.

### PRIORITY

This application claims priority to U.S. Provisional Patent Application No. 63/601,793, filed Nov. 22, 2023, the contents of which are hereby incorporated in their entirety.

### TECHNICAL FIELD

The present disclosure relates generally to data communication networks, and more specifically, to diagnosing faults on a shared bus within a local area network. Yet more specifically, the disclosure relates to diagnosing shared bus faults based on an indicator applied to a vector of amplitudes of signals transmitted over the bus.

### BACKGROUND

Ethernet networks in the automotive sector, usually referred to as “automotive Ethernet,” are multi-node or multi-drop networks that transmit high data volume. For example, when using high-resolution video cameras with high frame rates and great color depth, large amounts of data is transmitted. The increasing number of actuators and sensors within a vehicle (e.g., an automobile, a truck, a bus, a ship, and/or an aircraft), which, like cameras, usually communicate with a central control unit, also increases the data load within the vehicle.

Automotive Ethernet has been specified in the Institute of Electrical and Electronics Engineers (IEEE) standard 802.3bw since 2016. Accordingly, data transmission rates of up to 100 Mbit/s over unshielded cables with a single twisted pair (single twisted pair Ethernet (STPE)) are provided. Automotive Ethernets may also be 10Base-T1S (10 Mbps single pair Ethernet) networks over single twisted pair cables. Thus, both IEEE 802.3bw and 10Base-T1S may be considered as transmission over STPE cables.

STPE cables used for automotive Ethernet often endure cyclical mechanical loads resulting from the constant movement of the cable relative to automotive components, which may lead to fatigue in the cable. Cable fatigue may cause deterioration in the signal quality and the loss of the data connection. Defects in STPE cables are usually not visible because they occur within the cable. A diagnosis of the quality or a state of wear of STPE cables may be determined by measurement.

Time-domain reflectometers (TDR) measure reflections along a conductor by transmitting an incident signal onto the conductor and listening for its reflections. A conductor having uniform impedance, and which is properly terminated will produce no reflections and the incident signal will be absorbed by the termination at the far-end. A cable having impedance variations at discontinuities will produce reflections of the incident signal back to the source and the remaining incident signal will be absorbed by the termination at the far-end. The impedance of a discontinuity may be determined by measuring the amplitude of the reflected signal at the source. The distance along the conductor to the discontinuity may be determined by measuring the time it takes a pulse to return from the discontinuity.

Cable Diagnosis (CD) is a hardware system-test in wired networks used for self-diagnosis on cable damage. CD is a feature specified by the OpenAlliance SIG for automotive Ethernet but may also be used in non-automotive applications. In particular, CD is typically used to check for cable defects when automotive vehicles are manufactured. Test case failure types include, for example: (1) both bus wires open; (2) one bus wire open; (3) bus wires short to each other; (4) both bus wires short to ground (GND) or Vbat. (5) one bus wire short to GND or Vbat, and (6) false set of end-terminations.

However, existing hardware test systems and methods are unable to cover all corner cases in a multi-node or MultiDrop Network. Very large configurations are possible in 10Base-T1S networks depending on the number of nodes, distance between nodes, differences in node/cable/termination impedance, and location of fault, without limitation. Transceiver process, voltage, and temperature (PVT) variations can also add to ambiguity. Noise during testing may give inconsistent results for extreme network topologies. Hardware solutions may give incorrect results in extreme configurations and fault locations e.g., open may be diagnosed as terminated.

There is a need for shared bus diagnosis systems and methods to detect discontinuities that resolves cases, including corner cases, in multi-node or MultiDrop Networks, including very large 10Base-T1S network configurations having transceiver process, voltage, and temperature (PVT) variations.

### SUMMARY OF THE INVENTION

Aspects provide shared bus diagnosis systems and methods to detect faults (e.g., discontinuities, mechanical damage, incorrectly terminated) in multi-node or MultiDrop Networks, including very large 10Base-T1S network configurations having transceiver process, voltage, and temperature (PVT) variations based on an indicator applied to a vector of amplitudes of signals transmitted over the bus.

An aspect provides a method comprising: transmitting a pulse signal over a shared bus; capturing an observed signal, wherein the observed signal is a superimposition of the pulse signal and a reflection signal; comparing an amplitude of the observed signal to a plurality of threshold values; creating a vector indicating a given threshold at which the amplitude of the observed signal first exceeds one of the plurality of threshold values at a plurality of sampling times; applying an indicator to the vector; and diagnosing the shared bus based on the indicator.

According to an aspect, there is provided an apparatus comprising: a control circuit to: receive a plurality of sequences of bits, wherein a given one of the plurality of sequences of bits is indicative of an amplitude of the observed signal compared to a given one of a plurality of threshold values at a plurality of sampling times; creating a vector based on the plurality of sequences of bits, wherein the vector indicates, for a given one of the plurality of sampling times, a first threshold of the plurality of threshold values at which the amplitude of the observed signal exceeds one of the plurality of threshold values; apply an indicator to the vector; and diagnose a shared bus based on the indicator.

According to an aspect, there is provided a system including a shared bus; a transceiver coupled to the shared bus, and a control circuit coupled to the transceiver. The transceiver to: transmit a pulse signal over a shared bus; capture an observed signal, wherein the observed signal is a superimposition of the pulse signal and a reflection signal; compare an amplitude of the observed signal to a plurality of threshold values; and output a sequence of bits indicative of an amplitude of an observed signal compared to a plurality of threshold values at a given sampling time. The control circuit to: receive a plurality of sequences of bits, wherein a given one of the plurality of sequences of bits is indicative of an amplitude of the observed signal compared to a given one of a plurality of threshold values at a plurality of sampling times; creating a vector based on the plurality of sequences of bits, wherein the vector indicates, for a given one of the plurality of sampling times, a first threshold of the plurality of threshold values at which the amplitude of the observed signal exceeds one of the plurality of threshold values; apply an indicator to the vector; and diagnose a shared bus based on the indicator.

### BRIEF DESCRIPTION OF THE DRAWINGS

The figures illustrate aspects of systems and methods to diagnose a shared bus (e.g., identify faults such as open verses short verses terminated), for a variety of network configurations in multi-node or MultiDrop Networks, including very large 10Base-T1S network configurations having transceiver process, voltage, and temperature (PVT) variations, including many nodes, larger distances between nodes and fault locations, and differences in node, cable, or termination impedance, to resolve identified damage in corner cases in these network topologies. The diagnosis is based on an indicator applied to a vector of amplitudes of signals (i.e., transmitted signals and reflected signals) captured from the bus.

FIG. 1 illustrates a block diagram of at least a portion of a network (e.g., a wired local area network);

FIG. 2 depicts an example network segment including a node coupled to a communication bus;

FIG. 3 illustrates an example system including a transceiver and control circuit;

FIGS. 4A and 4B show example vectors illustrating matrices of amplitudes of the observed signals at a plurality of sample times and the resulting vectors;

FIG. 5 illustrates a graph of an example vector where the shared bus is properly terminated;

FIG. 6 illustrates a graph of an example vector where the shared bus is open;

FIG. 7 illustrates a graph of an example vector where the shared bus is shorted;

FIG. 8 illustrates a graph of an example vector where the shared bus has one wire shorted to ground while the other wire is open;

FIG. 9 illustrates a graph of an example vector where the shared bus is damaged close to the analyzing node;

FIG. 10 illustrates a graph of an example vector where the shared bus has an incorrect end-termination (e.g., a falsely added third end-termination);

FIG. 11 illustrates a method performed to diagnose a shared bus fault, according to examples of the present disclosure;

FIG. 12 illustrates a method performed to apply a settled state indicator, according to examples of the present disclosure;

FIG. 13 illustrates a method performed to apply a significant slope indicator, according to examples of the present disclosure;

FIG. 14 illustrates a method performed to apply a maximum amplitude indicator, according to examples of the present disclosure;

FIG. 15 illustrates a method performed to apply a voltage sum indicator, according to examples of the present disclosure;

FIG. 16 illustrates a method performed to apply a gradient indicator, according to examples of the present disclosure; and

FIG. 17 illustrates a method performed to apply a localized slope indicator, according to examples of the present disclosure.

The reference number for any illustrated element that appears in multiple different figures has the same meaning across the multiple figures, and the mention or discussion herein of any illustrated element in the context of any particular figure also applies to each other figure, if any, in which that same illustrated element is shown.

### DESCRIPTION

Aspects provide a systems and methods to diagnose faults of a shared bus in a network, which is typically used in automotive applications, based on an indicator applied to a vector of amplitudes of signals (i.e., transmitted signals and reflected signals) captured from the bus. Faults may be caused by a variety of factors including, but not limited to, mechanical damage, damage to the insulation surrounding the bus, and incorrect termination. The vector, may be compared against one or more indicators. For example, the vector may be compared against multiple indicators in a predefined order and stop when a result is found. As another example, the vector may be compared against all indicators. As a further example, the vector may be compared against any subset of indicators. The indicators may include analysis of the vector's settled state, signal slopes (e.g., slope of the entire signal, gradient after peak, and localized slope), signal maximum amplitude, and voltage sum.

Aspects use a 10BASE-T1S single-pair Ethernet physical layer (PHY) transceiver for 10 Mbit/s half duplex networking over a single pair of conductors to provide shared bus fault (open/short) diagnostics and signal quality indication support. The transceiver transmits a signal over the shared bus and receives reflected signals from the shared bus.

Aspects include features disclosed in U.S. Publication Number 2021/0058168, incorporated herein in its entirety for all purposes.

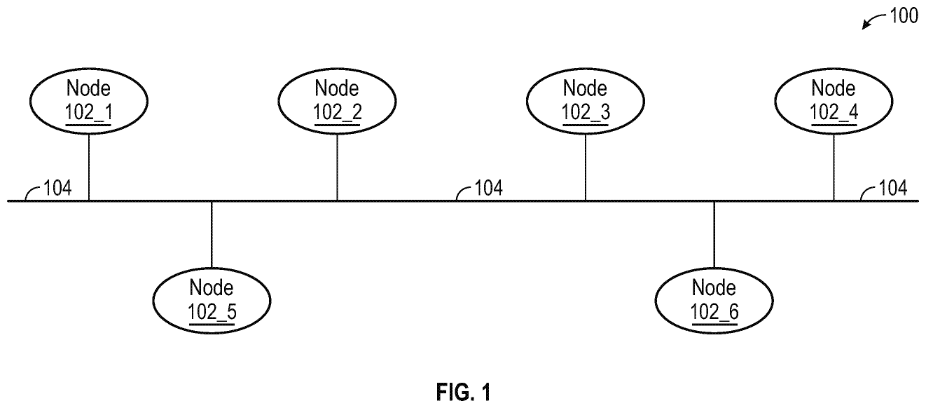

FIG. 1 illustrates a block diagram of at least a portion of a network (e.g., a wired local area network) 100, according to some examples. More specifically, network 100 may include a 10 Mbit/s Single Pair Ethernet (10SPE) network. Network 100 may include multiple nodes 102 operably coupled to a shared communication bus 104 (e.g., including one or more cables). More specifically, network 100 includes nodes 102_1, 102_2, 102_3, 102_4, 102_5, and 102_6, generally nodes 102. Although network 100 is depicted as having six nodes, the disclosure is not so limited, and a network may include more than six nodes (e.g., eight nodes, ten nodes, twelve nodes, or more) or less than six nodes (e.g., five nodes, three nodes, or two nodes).

Nodes 102_1, 102_2, 102_3, 102_4, 102_5, and 102_6 may communicate via communication bus 104, which may include, or be, a shared bus (e.g., a single twisted pair). As used herein, the term “shared bus” refers to a wired transmission medium, such as a single twisted pair, that conducts both transmit signals and receive signals over the same conductive structure (e.g., one or more cables).

Network 100 may be used in an automotive environment. More specifically, by way of non-limiting example, network 100 may connect one or more of nodes 102 to other nodes, a computer, and/or controller (e.g., within a vehicle). In this example, nodes 102 of network 100 may include, for example, an amplifier, a microphone, an antenna, a speaker, and/or a sensor, without limitation.

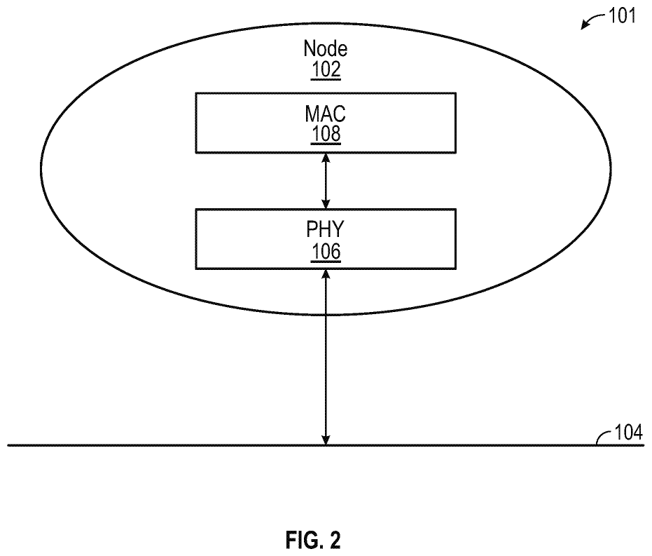

FIG. 2 depicts an example network segment 101 including node 102 (e.g., node 102_1, node 102_2, node 102_3, node 102_4, node 102_5, or node 102_6) coupled to communication bus 104. As shown in FIG. 2, node 102 includes physical layer (PHY) 106 operably coupled to media access control (MAC) layer 108. PHY 106 may serve as an interface for a physical connection between MAC 108 and a network or device via communication bus 104. In some examples, PHY 106 includes at least a portion of Ethernet physical layer circuitry. A PHY (e.g., PHY 106) may include a transceiver having transmit circuitry and receive circuitry, and detection circuitry including at least one signal detector.

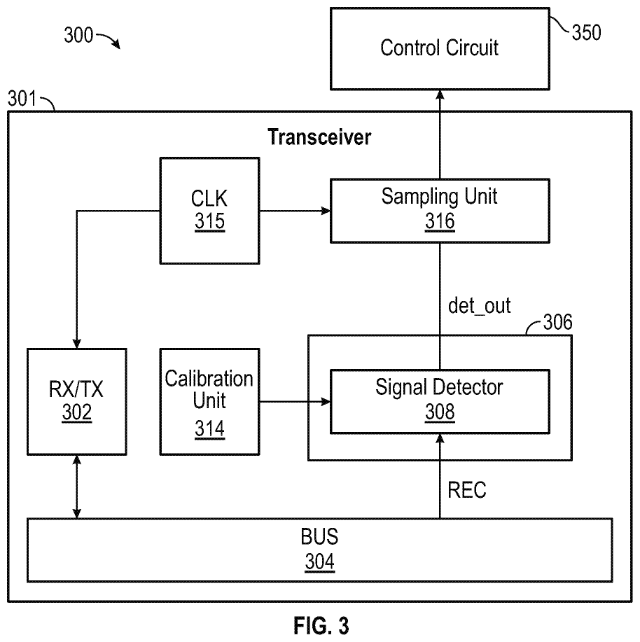

FIG. 3 illustrates an example system 300 including transceiver 301 and control circuit 350. For example, PHY 106 of FIG. 2 may include transceiver 301. Transceiver 301 includes receive and transmit circuitry 302, which may be coupled to a communication bus 304 and a MAC (not shown in FIG. 3, e.g., MAC 108 of FIG. 2). For example, communication bus 304 may include communication bus 104 of FIG. 1 and FIG. 2. Communication bus 304, which may be used for both transmitting and receiving data, may include a single twisted pair (e.g., an Unshielded Twisted Pair (UTP)). Transceiver 301 further includes control circuit 306, which may include signal detector 308, and calibration unit 314 for programming signal detector 308 with one or more threshold values. Control circuit 306 may be implemented in any suitable combination of analog and digital circuitry, such as a suitable microprocessor, control board, or other computing device having input and output interfaces for communicating with other devices, as well as memory or other storage for program logic/instructions that control circuit 306 executes to send and receive signals and process data. Calibration unit 314 may include a digital to analog converter (DAC). Signal detector 308 may include a comparator which may, generally, be a window comparator with symmetrical signal range and may compare a differential signal (i.e., a measured difference between the + and − inputs of the comparator) to a threshold created by the DAC.

Signal detector 308 may detect signals observed via communication bus 304. More specifically, a response signal (REC), which may include a differential signal, may be observed at signal detector 308 via communication bus 304. For a given sampling period of a number of sampling times, signal detector 308 may detect an amplitude of signal REC, compare the amplitude to a threshold value (provided by calibration unit 314), and convey a signal det_out. This process may be repeated for multiple thresholds (e.g., 64 thresholds).

Signal det_out may be supplied to sampling unit 316, which may store the values of signal det_out in a sequence of bits. The sequence of bits may be a logic value (e.g., 0 or 1) that is indicative of the amplitude of signal REC at a sampling time compared to the threshold value. If, for a sampling time, the absolute value of the amplitude of signal REC is equal to or greater than the threshold value, one of the sequence of bits may include a first logic value (e.g., a logic 1). If, for a sampling time, the absolute value of the amplitude of signal REC is less than the threshold value, one of the sequence of bits may be a second, different logic value (e.g., a logic 0). The sequence of bits may be the sequence of logic values representing the comparison at each threshold value (e.g., 00001111 . . . ).

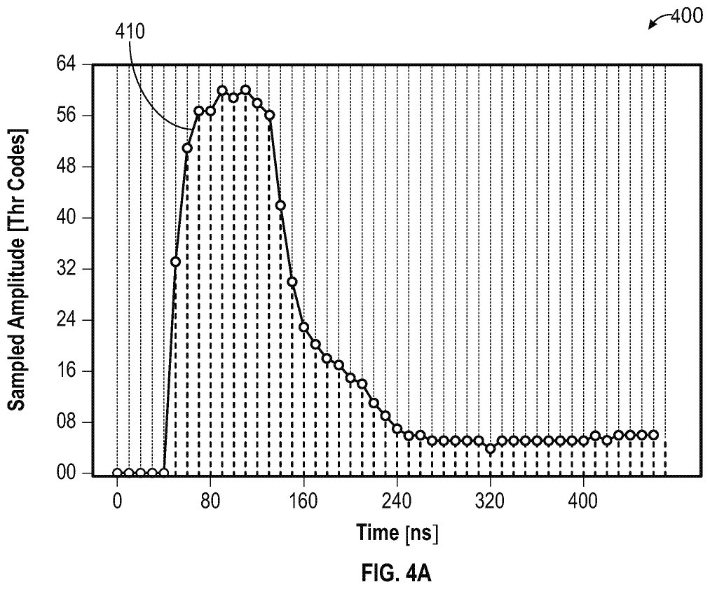

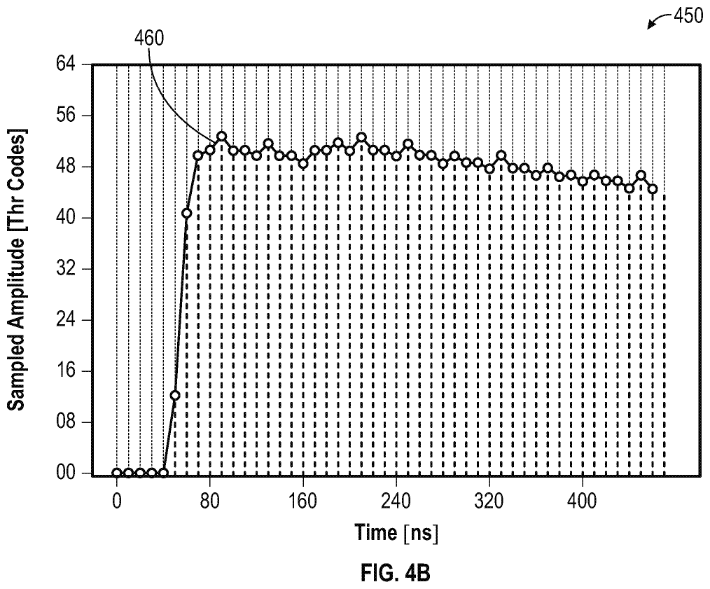

For a given threshold and for a given sampling time or period of a number of sampling times, control circuit 350 may create a vector of logic values of the sequence of bits representing signal det_out. This process may be repeated for multiple thresholds (e.g., 64 thresholds) and is described in more detail with respect to FIGS. 4A and 4B. Based on the vector, control circuit 350 may determine whether a fault exists, a fault type, and possibly a location of the fault. Also, control circuit 350 may generate a signal indicative of a fault, or lack thereof. Control circuit 350 may be implemented in any suitable combination of analog and digital circuitry, such as a suitable microprocessor, control board, or other computing device having input and output interfaces for communicating with other devices, as well as memory or other storage for program logic/instructions that control circuit 350 executes to send and receive signals and process data. While control circuit 350 is shown in FIG. 3 as separate from transceiver 301, in some examples, control circuit 350 may be part of transceiver 301.

Transceiver 301 may also include a clock 315 (e.g., a 100 MHz clock) for generating a clock signal, which may be conveyed to transmit and receive circuitry 302 and sampling unit 316. The clock signal may be used to trigger sampling and/or determine a time duration between signal transmission (e.g., a rising edge of a transmit pulse) and reception of an observed signal. At least some portions of receive and transmit circuitry 302 (e.g., a pulse shaper and/or a driver of the transmit circuitry) and/or at least some portions of a receiver (e.g., a signal detector of the receive circuitry) may be in a chip separate from a chip including signal detector 308 and control circuit 350.

FIGS. 4A and 4B show example graphs 400 and 450, respectively, illustrating matrices of amplitudes of the observed signals at a plurality of sample times and the resulting vectors 410 and 460. A transceiver, such as transceiver 301 shown in FIG. 3, may transmit a low frequency pattern pulse signal comprising a continuous square wave with a pulse wider than the observation period. The transceiver may receive an observed signal. The transceiver then compares the observed signal to multiple threshold values. Specifically, a comparator, such as a comparator in signal detector 308 shown in FIG. 3, may compare the observed signal to multiple thresholds (e.g., thresholds 0 through 63). For a given threshold, the signal detector assigns a logic value correlating to whether the observed signal exceeds the threshold (e.g., logic value “1” if the observed signal exceeds the threshold, otherwise logic value “0”). This logic value is referred to as a threshold code. The sampling unit, such as sampling unit 316 shown in FIG. 3, may output these logic values as a sequence of bits indicating the comparison of the observed signal to a given threshold across the sampling time steps. The sampling unit may output multiple sequences of bits corresponding to multiple thresholds. The control circuit receives the multiple sequences of bits and creates a vector of the bits. The control circuit then sums the number of instances that the observed signal exceeds the thresholds at a given point in time. For example, as illustrated in FIG. 4A, at time 0 ns, the observed signal does not exceed any threshold and then at time 50 ns, the observed signal exceeds the amplitude represented by set thresholds 33 times. While FIGS. 4A and 4B show 48×64 bit matrices, wherein the horizontal axis indicates memory having 48 bits corresponding to a step size of 10 ns and a time range of 480 ns, and the vertical axis provides 64 thresholds indicating the amplitude of the threshold codes (e.g., the number of instances the observed signal exceeds the threshold), the matrix can have more or fewer bits for either the horizontal axis, the vertical axis, or both. The control circuit may then create vectors 410 and 460 that represent the amplitude of the threshold codes across time.

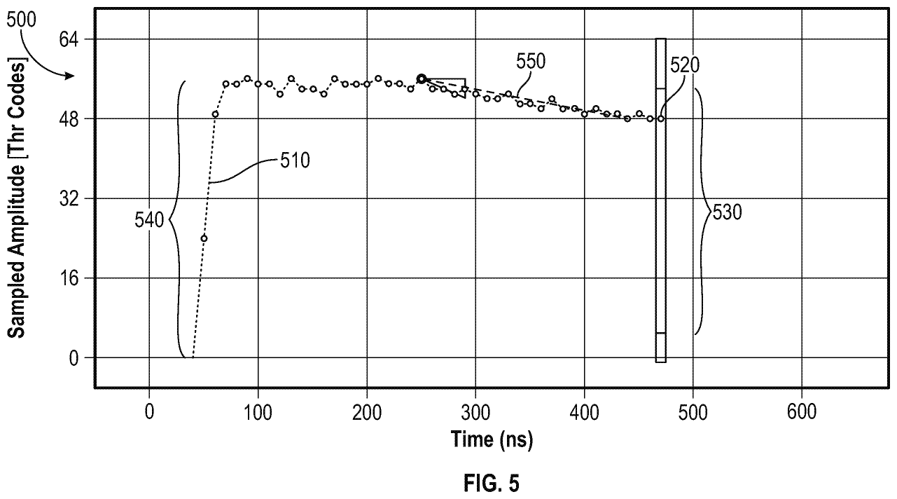

The control circuit may analyze vectors 410 and/or 460 against one or more indicators. These indicators may include a settled state indicator, a significant slope indicator, a maximum amplitude indicator, a voltage sum indicator, a gradient indicator, and/or a localized slope indicator, without limitation. Examples of the application of these indicators is described with respect to FIGS. 5-10 below. While FIGS. 5-10 illustrate the application of a given subset of indicators, for clarity, not every indicator is illustrated in every example. As described with respect to FIG. 11, the control circuit may analyze the. vectors by sequentially stepping through the indicators, applying each indicator or a subset of indicators until the control circuit reaches a confidence level in its diagnosis.

FIG. 5 illustrates a graph 500 of example vector 510 where the shared bus (e.g., communications bus 104 shown in FIG. 1) is properly terminated. Vector 510 may be created using the process described with respect to FIGS. 4A and 4B. The vector is then analyzed using one or more of the indicators to determine the status of the shared bus. For example, control circuit 350 may analyze a predetermined sample of vector 510 and compare this sample against empirically pre-defined thresholds to determine whether the shared bus is terminated, open, or shorted. When the sample is within the pre-defined threshold range, the shared bus may be terminated, when the sample is above the pre-defined threshold range, the shared bus may be open, and when the sample is below the pre-determined threshold, the shared bus may be shorted. The predetermined sample may be a sample captured after at least twice the propagation time over the cable has elapsed. For example, if the shared bus were 25 meters in length and was damaged near the end of the shared bus, the node transmitting the pulse signal would not receive an observed signal containing a reflection until after twice the propagation time over the shared bus has elapsed. Selecting a sample beyond this time period may allow the observed signal to settle to a state that allows the control circuit to distinguish a fault type. In the example shown in FIG. 5, the control circuit analyzes the last sample 520 in vector 510. In this example, if sample 520 is within pre-determined threshold 530 (e.g., between approximately 5 and 56), the shared bus may be properly terminated, if sample 520 is below pre-determined threshold range 530 (e.g., below approximately 5), the shared bus may be shorted, and if sample 520 is above pre-determined threshold 530 (e.g., above approximately 56), the shared bus may be open. The empirically pre-defined thresholds may be determined based on data about the system of which shared bus is a part. The thresholds may depend, for example, on the application, temperature, voltage, and/or type of transceiver. This analysis is referred to as a “settled state indicator.”

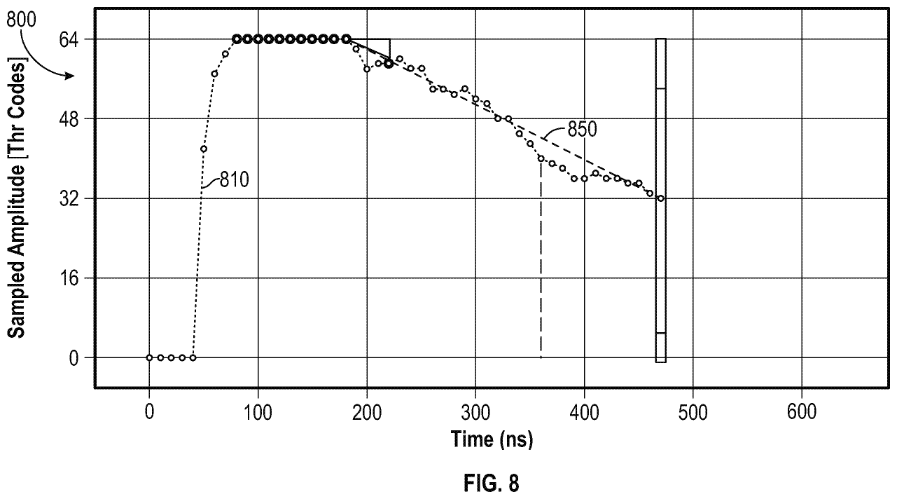

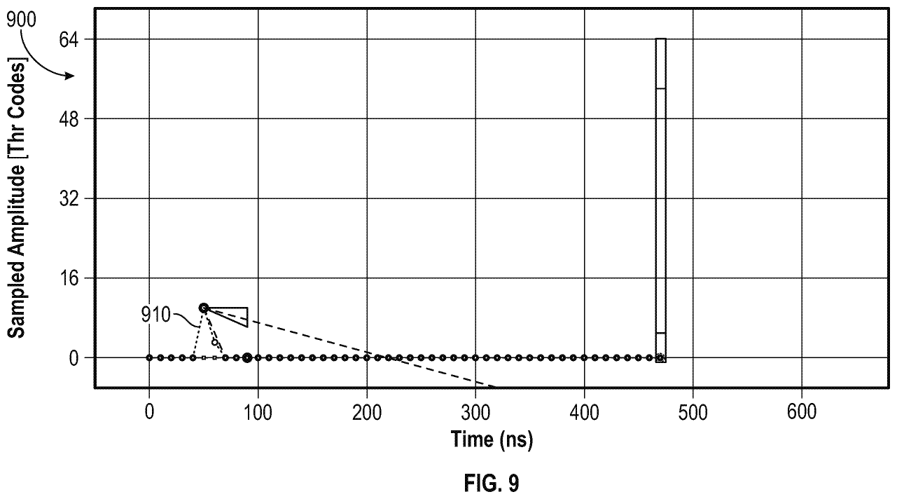

The control circuit 350 may also analyze vector 510 using other indicators to confirm or further refine its analysis. For example, the control circuit may then apply a significant slope indicator. Using this indicator, the control circuit 350 analyzes vector 510 to identify the number and direction (e.g., positive or negative) of the significant slopes of the vector. For example, a slope may be deemed “significant” when it is larger than 7 steps in the threshold code between adjacent samples. In the example shown in FIG. 5, vector 510 has one significant slope 540 having a positive direction. This significant slope occurs beginning at approximately time 40 ns. From 40 ns to the next time-step, the threshold codes of vector 510 increase from 0 to approximately 24, increase from approximately 24 to approximately 48 at the next time-step, and then increase from approximately 48 to 56 at the third time step. The transition between the three adjacent time-steps with slopes exceeding 7 steps in the threshold value may be considered a single significant slope. A second significant slope is not identified until a slope of less than 7 steps between adjacent steps is detected. Vectors with a single significant slope are considered terminated because the single significant slope is caused by the transmitted pulse signal. As explained below with respect to FIGS. 8 and 9, a vector with two significant slopes may indicate that the shared bus is faulted because the second significant slope would be caused by a reflection signal created by a fault on the shared bus. Specifically, a vector with two significant slopes where both slopes are positive indicates that the shared bus may be open and a vector with two significant slopes where one slope is positive and one slope is negative indicates that the shared bus may be shorted.

The control circuit 350 may further analyze vector 510 using a gradient indicator. In some systems, the transceiver may include on-chip filtering that results in vector 510 having a slightly negative slope, referred to as a “drooping” slope. A drooping slope does not indicate a problem with the shared bus, but if the gradient of the drooping slope becomes too steep, it may indicate that the shared bus is faulted (e.g., may exhibit a type of cable damage, or an improper set of terminations). The control circuit may calculate the gradient of the drooping slope and compare it against a predetermined threshold to determine if the gradient is too steep. For example, the gradient may be calculated using the following formula:

$$gradient = \frac{( {y}_{1} - {y}_{2} ) * 10}{( {x}_{2} - {x}_{1} )}$$

where y₁ and y₂ are two threshold codes of vector 510 and x₁ and x₂ are the corresponding time-steps. According to one criterion, the predetermined threshold may be calculated based on the highest threshold code of the vector to the lowest threshold code after the highest threshold code. If the gradient is larger than a predetermined threshold, for example six (6), the shared bus may be faulted (e.g., open or shorted). According to another criterion, the predetermined threshold may be calculated based on the highest threshold code of the vector and the last sample in the vector. If the gradient is larger than predetermined threshold, for example three (3), the shared bus may be faulted (e.g., open or shorted). In the example shown in FIG. 5, the gradient of the drooping slope (labeled 550) does not exceed a predetermined threshold and therefore indicates that the shared bus may be properly terminated.

Therefore, in the example shown in FIG. 5, analysis of vector 510 using the different indicators leads the control circuit 350 to determine that the shared bus may be properly terminated, and without a fault. While FIG. 5 illustrates the application of a settled state indicator, significant slope indicator, and gradient indicator, the control circuit 350 may analyze vector 510 using more or fewer indicators.

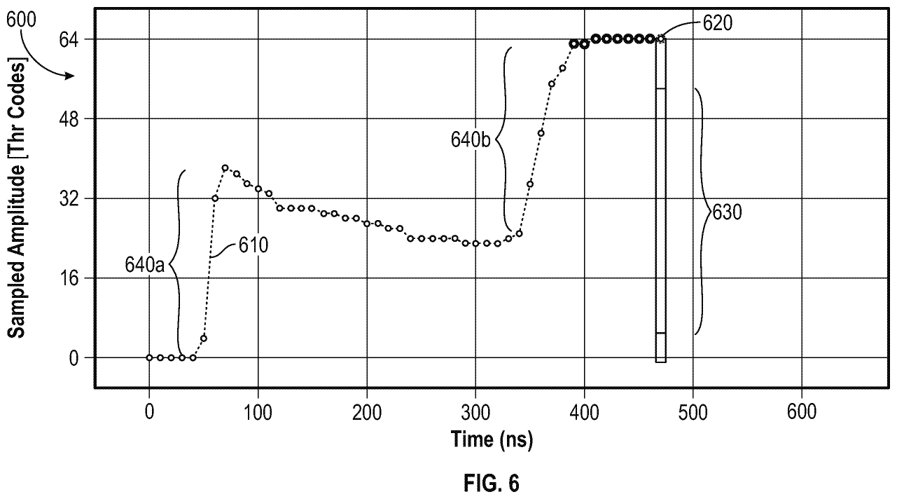

FIG. 6 illustrates a graph 600 of example vector 610 where the shared bus is open. Vector 610 may be created using the process described with respect to FIGS. 4A and 4B. Vector 610 is then analyzed using one or more of the indicators to determine the status of the shared bus. For example, beginning with the settled state indicator, the control circuit may analyze a predetermined sample, for example the last sample, of vector 610 and compare this sample to empirically determined thresholds. As an example, using the same thresholds described with respect to FIG. 5, in FIG. 6, the final sample 620 is approximately 64, outside of pre-determined threshold range 630, indicating that the shared bus may be open.

The control circuit may also analyze vector 610 using other indicators to confirm or further refine its analysis. For example, the control circuit may then apply the significant slope indicator. Using this indicator, the control circuit analyzes vector 610 to identify the number and direction (e.g., positive or negative) of the significant slopes of the vector. A vector with two significant slopes may indicate that the shared bus is faulted (e.g., open or shorted). Specifically, a vector with two significant slopes where both slopes are positive indicates that the shared bus may be open and a vector with two significant slopes where one slope is positive and one slope is negative indicates that the shared bus may be shorted. In the example shown in FIG. 6, vector 610 has two significant slopes 640a and 640b. The first significant slope 640a has a positive direction and the second significant slope 640b also has a positive direction. This indicates that the shared bus may be open.

As another example, the control circuit may also use a maximum amplitude indicator. Specifically, the control circuit may analyze vector 610 to identify the presence of consecutive samples that are at, or beyond, a predetermined maximum amplitude. For example, the predetermined maximum amplitude may be beyond the measurement range of the transceiver or may be at the maximum amplitude of the threshold codes. When multiple consecutive samples are at, or beyond, the predetermined maximum amplitude, the shared bus is considered open. In FIG. 6, after the approximate times of 375 ns, vector 610 is beyond the predetermined maximum amplitude of 64, indicating that the shared bus may be open.

Therefore, in the example shown in FIG. 6, analysis of vector 610 using three different indicators leads the control circuit 350 to determine that the shared bus is open. While FIG. 6 illustrates the application of a settled state indicator, significant slope indicator, and maximum amplitude indicator, the control circuit 350 may analyze vector 610 using more or fewer indicators.

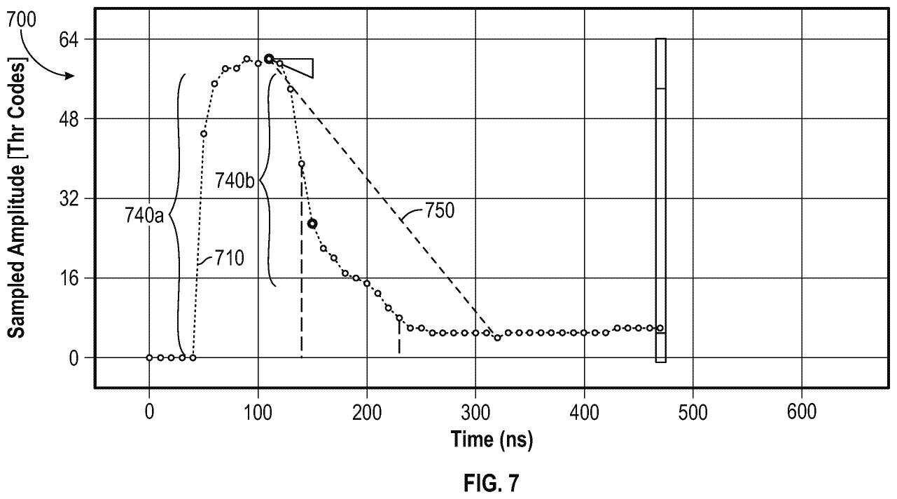

FIG. 7 illustrates a graph 700 of example vector 710 where the shared bus is shorted. Vector 710 may be created using the process described with respect to FIGS. 4A and 4B. Vector 710 is then analyzed using one or more of the indicators to determine the status of the shared bus. For example, the control circuit 350 may apply the significant slope indicator. Using this indicator, the control circuit analyzes vector 710 to identify the number and direction (e.g., positive or negative) of the significant slopes of the vector. A vector with two significant slopes may indicate that the shared bus is faulted (e.g., open or shorted). Specifically, a vector with two significant slopes where both slopes are positive indicates that the shared bus may be open and a vector with two significant slopes where one slope is positive and one slope is negative indicates that the shared bus may be shorted. In the example shown in FIG. 7, vector 710 has two significant slopes 740a and 740b. The first significant slope 740a has a positive direction and the second significant slope 740b has a negative direction. This indicates that the shared bus may be shorted.

The control circuit may also analyze vector 710 using a gradient indicator. As explained with respect to FIG. 5, the transceiver may include on-chip filtering that results in vector 710 having a slightly negative slope, referred to as a “drooping” slope. A drooping slope does not indicate a problem with the shared bus, but if the gradient of the drooping slope becomes too steep, it may indicate that the shared bus is not properly terminated. The control circuit may calculate the gradient of the drooping slope and compare it against a predetermined threshold to determine if the gradient is too steep. In the example shown in FIG. 7, the gradient of the drooping slope (labeled 750) exceeds a predetermined threshold and therefore indicates that the shared bus may be shorted.

Therefore, in the example shown in FIG. 7, analysis of vector 710 using the different indicators leads the control circuit to determine that the shared bus may be shorted. While FIG. 7 illustrates the application of a significant slope indicator and gradient indicator, the control circuit 350 may analyze vector 710 using more or fewer indicators.

FIG. 8 illustrates a graph 800 of example vector 810 where the shared bus has one wire shorted to ground while the other wire is open. Vector 810 may be created using the process described with respect to FIGS. 4A and 4B. Vector 810 is then analyzed using one or more of the indicators to determine the status of the shared bus. For example, the control circuit 350 may use a maximum amplitude indicator. Specifically, the control circuit 350 may analyze vector 810 to identify the presence of consecutive samples that are at or beyond a predetermined maximum amplitude. For example, the predetermined maximum amplitude may be beyond the measurement range of the transceiver or may be at the maximum amplitude of the threshold codes. When multiple consecutive samples are at or beyond the predetermined maximum amplitude, the shared bus is considered open or shorted. In FIG. 8, between the approximate times of 75 and 175 ns, vector 810 is beyond the predetermined maximum amplitude of 64, indicating that the shared bus may be faulted.

The control circuit may also analyze vector 810 using a gradient indicator. The control circuit may calculate the gradient 850 of the drooping slope and compare it against a predetermined threshold to determine if the gradient is too steep. In the example shown in FIG. 8, the gradient of the drooping slope (labeled 850) exceeds a predetermined threshold and therefore indicates that the shared bus may be shorted.

Therefore, in the example shown in FIG. 8, analysis of vector 810 using the different indicators leads the control circuit to determine that the shared bus may be shorted. While FIG. 8 illustrates the application of a maximum amplitude indicator and gradient indicator, the control circuit 350 may analyze vector 810 using more or fewer indicators.

FIG. 9 illustrates a graph 900 of example vector 910 where the shared bus is faulted (e.g., damaged or shorted) close to the transmitting node. Vector 910 may be created using the process described with respect to FIGS. 4A and 4B. Vector 910 is then analyzed using one or more of the indicators to determine the status of the shared bus. For example, the control circuit 350 may analyze vector 910 using a voltage sum indicator. The control circuit may sum the threshold codes of the vector and compare the sum to a predetermined threshold. For example, vector 910 has two non-zero threshold codes: approximately 10 and 5, resulting in a sum of 15. When the sum is below the predetermined threshold, in this case 1500, the shared bus may be faulted (e.g., open or shorted).

Therefore, in the example shown in FIG. 9, analysis of vector 910 using the different indicators leads the control circuit to determine that the shared bus may be shorted. While FIG. 9 illustrates the application of a voltage sum indicator, the control circuit 350 may analyze vector 910 using more indicators.

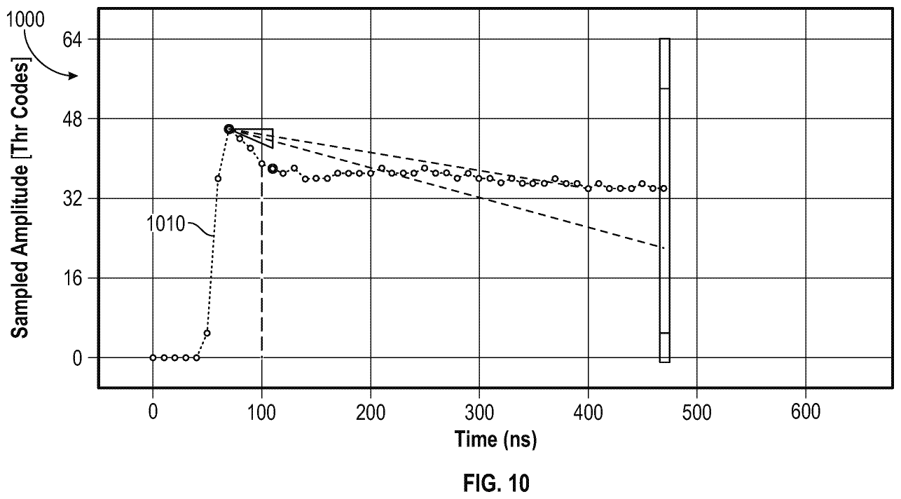

FIG. 10 illustrates a graph 1000 of example vector 1010 where the shared bus has an incorrect end-termination (e.g., a falsely added third end-termination). Vector 1010 may be created using the process described with respect to FIGS. 4A and 4B. Vector 1010 is then analyzed using one or more of the indicators to determine the status of the shared bus. For example, the control circuit 350 may analyze vector 1010 using a localized slope indicator. In the example shown in FIG. 10, the control circuit 350 looks at the slope of vector 1010 at a predetermined location and determines if the slope exceeds a predetermined threshold. For example, the control circuit 350 may identify the maximum threshold code of vector 1010. The control circuit 350 may then determine the slope of vector 1010 between the time of the maximum threshold code and a point four time-steps later. If the threshold code of vector 1010 four time-steps after the time of the maximum amplitude is over four threshold codes lower than the maximum threshold code, the predetermined threshold is exceeded, it being understood that the use of four time-steps and four threshold codes are a non-limiting example. When the localized slope exceeds the predetermined threshold the analysis indicates that the shared bus may be shorted. In the example shown in FIG. 11, the maximum threshold code is approximately 46. Four time-steps later, the threshold code of vector 1010 is approximately 39. Therefore, over the four time-steps, the threshold code of vector 1010 is greater than four threshold codes less and the localized slope exceeds the threshold, thus indicating that the shared bus is faulted.

Therefore, in the example shown in FIG. 10, analysis of vector 1010 using the different indicators leads the control circuit 350 to determine that the shared bus is shorted. While FIG. 10 illustrates the application of a localized slope indicator, the control circuit 350 may analyze vector 1010 using more indicators.

FIG. 11 illustrates a method performed to diagnose a shared bus fault, according to examples of the present disclosure. Method 1100 may be implemented using a transceiver, such as transceiver 301 shown in FIG. 3, control circuit, such as control circuit 350 shown in FIG. 3, or any other system operable to implement method 1100. Although examples have been described above, other variations and examples may be made from this disclosure without departing from the spirit and scope of these disclosed examples.

Method 1100 begins at block 1105 where the transceiver may transmit a pulse signal over a shared bus.

At block 1110, the transceiver may capture an observed signal. The observed signal is a superimposition of the pulse signal and a reflection signal.

At block 1115, the transceiver may compare the observed signal to multiple threshold values. Specifically, a comparator in a signal detector of the transceiver may compare the observed signal to multiple thresholds (e.g., thresholds 0 through 63). As described with respect to FIGS. 4A and 4B, for a given threshold, a signal detector in the transceiver outputs a result of the comparison to a sampling unit in the transceiver that may output a sequence of bits representing the logic value correlating to whether the observed signal exceeds the threshold (e.g., logic value “1” if the observed signal exceeds the threshold, otherwise logic value “0”). The control circuit then assigns a value based on the number of instances that the observed signal exceeds the thresholds at a given point in time. Alternatively, the control circuit may receive the value of the threshold code when the comparison changes to 1, and stores that value.

At block 1120, the control circuit may create a vector indicating a threshold code at which the observed signal first exceeds one of the plurality of threshold values from block 1115, as described with respect to FIGS. 4A and 4B. The vectors may represent the amplitude of the observed signal over time.

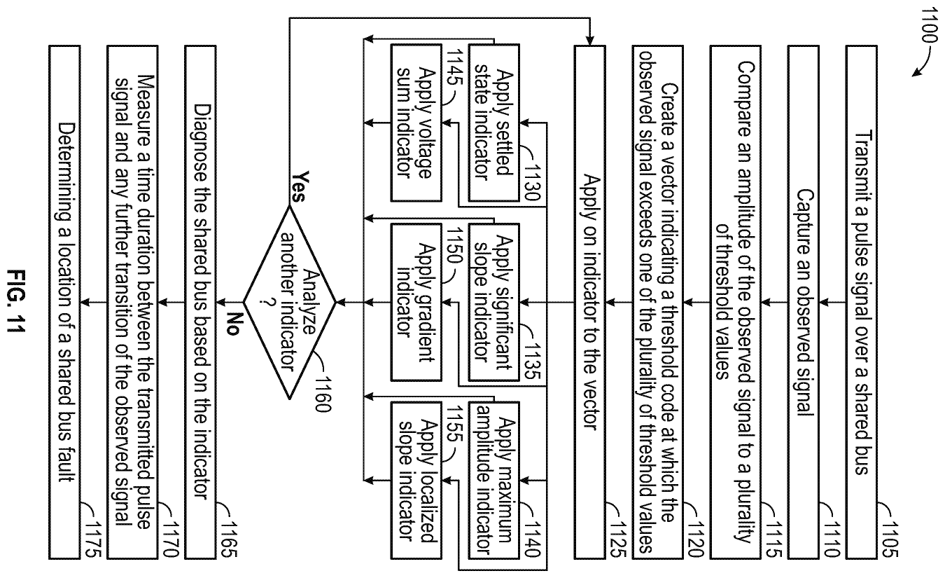

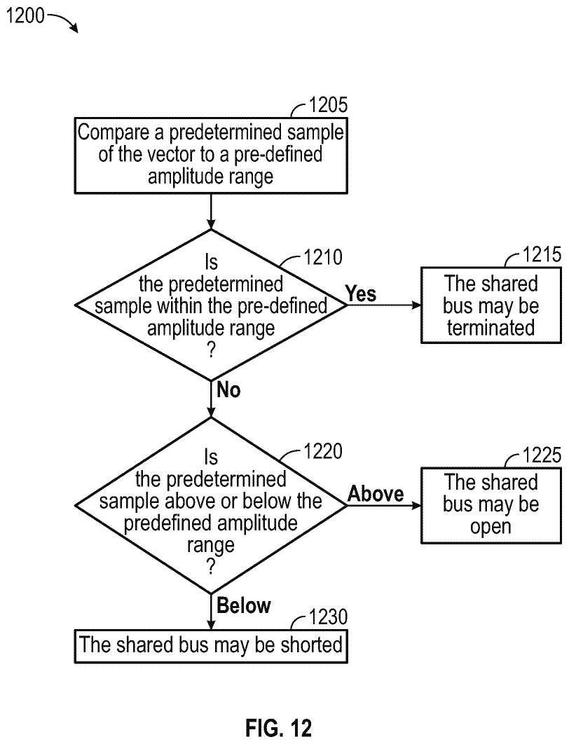

At block 1125, the control circuit may apply an indicator to the vector. The control circuit may select one of a number of indicators to apply to the vector. Specifically, the control circuit may apply a settled state indicator (block 1130), a significant slope indicator (block 1135), a maximum amplitude indicator (block 1140), a voltage sum indicator (block 1145), a gradient indicator (block 1150), or a localized slope indicator (block 1155). The indicators are described in further detail in FIGS. 12-17.

At block 1160, the control circuit may determine whether to apply another indicator to the vector. For example, the control circuit may apply all indicators or apply a subset of indicators until the control circuit has diagnosed the shared bus. For example, the control circuit may analyze the. vectors by sequentially stepping through the indicators, applying each indicator or a subset of indicators until the control circuit reaches a confidence level in its diagnosis. If the control circuit applies another indicator, method 1100 returns to block 1125. If not, method 1100 proceeds to block 1165 where the control circuit diagnoses the shared bus based on the applied indicators. The control circuit may diagnose the shared bus (e.g., terminated or faulted) and, if applicable, determine the type of fault (e.g., open or shorted).

At block 1170, the control circuit may measure a time duration on the observed signal between the pulse signal (transmitted at block 1105) and any further transition of the observed signal. To account for internal delays, the control circuit may measure the first rising edge of the start of the transmitted pulse signal and the location of any further detected edge of the observed signal. At block 1175, the control circuit may determine a location of a shared bus fault based on the time duration measured at block 1170. For example, if the detected time duration is 30 ns and the propagation rate is 5 nanoseconds/meter, the control circuit may determine that the shared bus fault is about 3 meters away.

Modifications, additions, or omissions may be made to method 1100 without departing from the scope of the present disclosure. For example, the operations of method 1100 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

FIG. 12 illustrates a method performed to apply a settled state indicator at block 1130 of FIG. 11, according to examples of the present disclosure. Modifications, additions, or omissions may be made to method 1200 without departing from the scope of the present disclosure. For example, the operations of method 1200 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1205, the control circuit may compare a predetermined sample of the vector to an empirically pre-defined amplitude range. At block 1210, the control circuit may determine whether the predetermined sample is within the pre-defined amplitude range. If so, at block 1215, the control circuit may determine that the shared bus may be terminated. If not, at block 1220, the control circuit may determine whether the predetermined sample is above or below the pre-defined amplitude range. If the predetermined sample is above the pre-defined amplitude range, at block 1225, the control circuit may determine that the shared bus may be open. If the predetermined sample is above the pre-defined amplitude range, at block 1230, the control circuit may determine that the shared bus may be shorted.

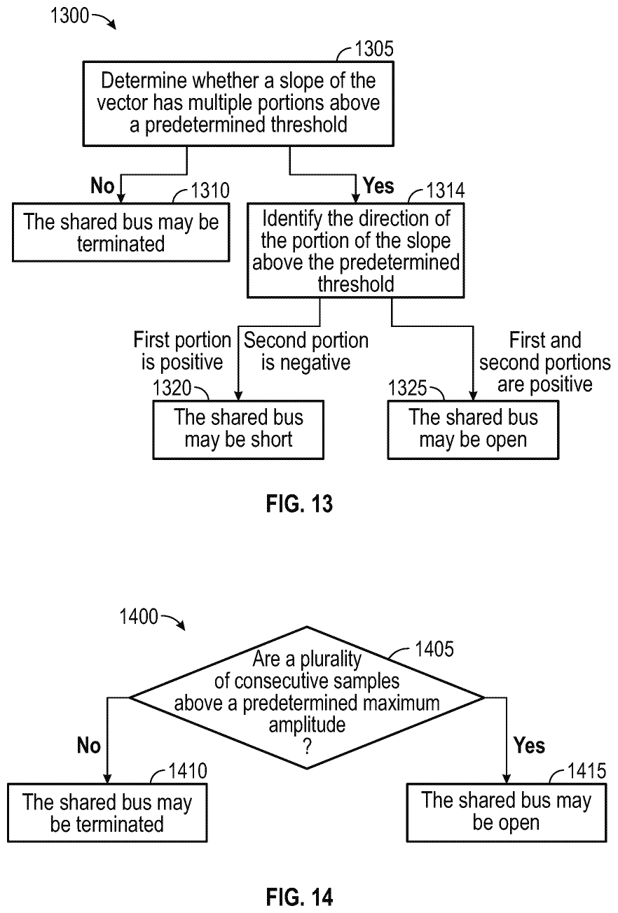

FIG. 13 illustrates a method performed to apply a significant slope indicator at block 1135 of FIG. 11, according to examples of the present disclosure. Modifications, additions, or omissions may be made to method 1300 without departing from the scope of the present disclosure. For example, the operations of method 1300 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1305, the control circuit may determine whether a slope of the vector has a portion above a predetermined slope threshold. If the vector does not have a portion of the slope above a predetermined slope threshold, at block 1310, the control circuit may determine that the shared bus may be terminated. If the vector has multiple slope portions above a predetermined threshold, at block 1315, the control circuit may identify the direction of the portion or portions of the slope that is above the predetermined threshold. If one portion is positive and one portion is negative, at block 1320, the control circuit may determine that the shared bus may be shorted. If all portions are positive, at block 1325, the control circuit may determine that the shared bus may be open.

FIG. 14 illustrates a method performed to apply a maximum amplitude indicator at block 1140 of FIG. 11, according to examples of the present disclosure. Modifications, additions, or omissions may be made to method 1400 without departing from the scope of the present disclosure. For example, the operations of method 1400 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1405, the control circuit may determine whether a plurality of consecutive samples in the vector are above a predetermined amplitude. If there are no multiple consecutive samples above the predetermined amplitude, at block 1410, the control circuit may determine that the shared bus may be terminated. If there are multiple consecutive samples above the predetermined amplitude, at block 1415, the control circuit may determine that the shared bus may be open.

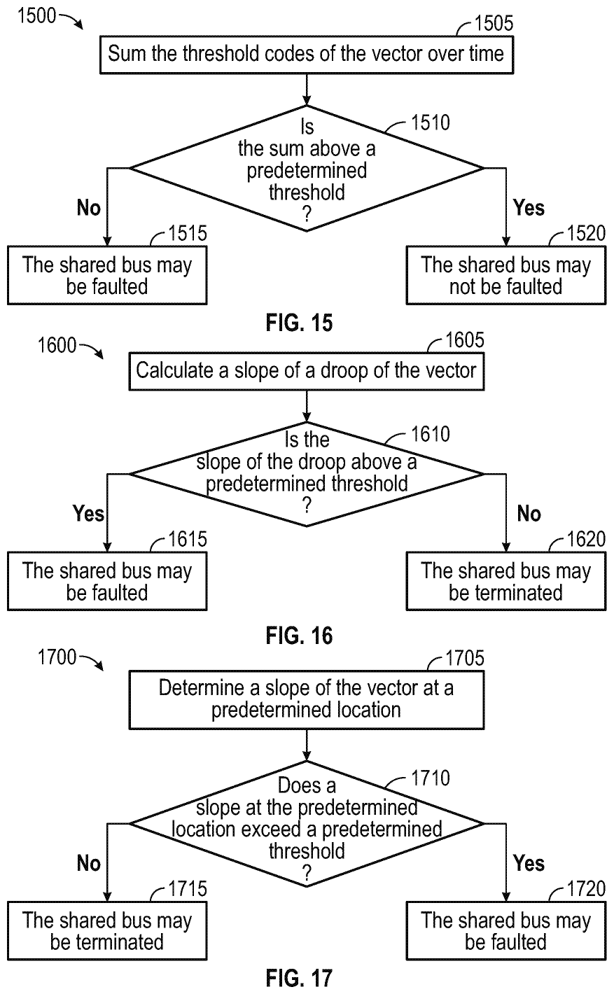

FIG. 15 illustrates a method performed to apply a voltage sum indicator at block 1145 of FIG. 11, according to examples of the present disclosure. Modifications, additions, or omissions may be made to method 1500 without departing from the scope of the present disclosure. For example, the operations of method 1500 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1505, the control circuit may sum the threshold codes of the vector over time. At block 1510, the control circuit may determine whether the sum is above a predetermined threshold. If the sum is not above a predetermined threshold, at block 1515, the control circuit may determine that the shared bus may be faulted. If the sum of the threshold codes is above a predetermined threshold, at block 1520, the control circuit may determine that the shared bus may not be faulted. When the control circuit reaches the result in block 1520, the control circuit may determine that it is to analyze another indicator to further diagnose the share bus, as described with respect to block 1160 in FIG. 11.

FIG. 16 illustrates a method performed to apply a gradient indicator at block 1150 of FIG. 11, according to examples of the present disclosure. Modifications, additions, or omissions may be made to method 1600 without departing from the scope of the present disclosure. For example, the operations of method 1600 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1605, the control circuit may calculate a slope of a droop of the vector. At block 1610, the control circuit may determine whether the slope of the droop is above a predetermined threshold. If the integrated voltage is above a predetermined threshold, at block 1615, the control circuit may determine that the shared bus may be faulted. If the integrated voltage is not above a predetermined threshold, at block 1620, the control circuit may determine that the shared bus may be terminated.

FIG. 17 illustrates a method performed to apply a localized slope indicator at block 1155 of FIG. 11, according to examples of the present disclosure. Modifications, additions, or omissions may be made to method 1700 without departing from the scope of the present disclosure. For example, the operations of method 1700 may be implemented in differing order. Furthermore, the outlined operations and actions are only provided as examples, and some of the operations and actions may be optional, combined into fewer operations and actions, or expanded into additional operations and actions without detracting from the essence of the disclosed examples.

At block 1705, the control circuit may calculate a slope of the vector at a predetermined location. The predetermined location may be between the maximum threshold code of the vector and a point four time-steps later. At block 1710, the control circuit may determine whether the slope of the vector at the predetermined location exceeds a predetermined threshold (e.g., the threshold code of the vector is more than four threshold codes less than the maximum threshold code at the point four time-steps after the time of the maximum threshold code). If the slope of the vector at the predetermined location is not above a predetermined threshold, at block 1715, the control circuit may determine that the shared bus may be terminated. If the slope of the vector at the predetermined location is above a predetermined threshold, at block 1720, the control circuit may determine that the shared bus may be faulted (e.g., open or shorted).

Although examples have been described above, other variations and examples may be made from this disclosure without departing from the spirit and scope of these disclosed examples.

1. A method comprising:
transmitting a pulse signal over a shared bus;
capturing an observed signal, wherein the observed signal is a superimposition of the pulse signal and a reflection signal;
comparing an amplitude of the observed signal to a plurality of threshold values;
creating a vector indicating a given threshold at which the amplitude of the observed signal first exceeds one of the plurality of threshold values at a plurality of sampling times;
applying an indicator to the vector; and
diagnosing the shared bus based on the indicator.

2. The method of claim 1, comprising:
measuring a time duration on the observed signal between the pulse signal and a transition of the observed signal; and
determining a location of a shared bus fault based on the time duration.

3. The method of claim 1, wherein the indicator is a settled state indicator; and
diagnosing the shared bus includes comparing a predetermined sample of the vector to a pre-defined amplitude range.

4. The method of claim 3, wherein diagnosing the shared bus includes:
determining that the shared bus is terminated when the predetermined sample of the vector is within the pre-defined amplitude range;
determining that the shared bus is shorted when the predetermined sample of the vector is below the pre-defined amplitude range; and
determining that the shared bus is open when the predetermined sample of the vector is above the pre-defined amplitude range.

5. The method of claim 1, wherein the indicator is a significant slope indicator; and
diagnosing the shared bus includes determining whether a slope of the vector has multiple portions above a predetermined threshold.

6. The method of claim 5, wherein diagnosing the shared bus includes:
determining that the shared bus is terminated when the slope of the vector has one portion above the predetermined threshold;
determining that the shared bus is short when the slope of the vector has two portions above the predetermined threshold, a slope of a first portion above the predetermined threshold is positive and a slope of a second portion above the predetermined threshold is negative; and
determining that the shared bus is open when the slope of the vector has two portions above the predetermined threshold, a slope of a first portion above the predetermined threshold is positive and a slope of a second portion above the predetermined threshold is positive.

7. The method of claim 1, wherein the indicator is a maximum amplitude indicator; and
diagnosing the shared bus includes determining whether a plurality of consecutive samples of the vector are beyond a predetermined maximum amplitude.

8. The method of claim 1, wherein the indicator is a voltage sum indicator; and
diagnosing the shared bus includes summing a plurality of threshold codes the vector over time and comparing the sum to a predetermined threshold.

9. The method of claim 1, wherein the indicator is a gradient indicator; and
diagnosing the shared bus includes analyzing a slope of a droop of the vector to determine whether the slope of the droop exceeds a predetermined threshold.

10. The method of claim 1, wherein the indicator is a localized slope indicator; and
diagnosing the shared bus includes analyzing a slope of the vector at a predetermined location to determine whether the slope exceeds a predetermined threshold.

11. The method of claim 1, comprising determining a fault type.

12. An apparatus comprising:
a control circuit to:
receive a plurality of sequences of bits, wherein a given one of the plurality of sequences of bits is indicative of an amplitude of the observed signal compared to a given one of a plurality of threshold values at a plurality of sampling times;
creating a vector based on the plurality of sequences of bits, wherein the vector indicates, for a given one of the plurality of sampling times, a first threshold of the plurality of threshold values at which the amplitude of the observed signal exceeds one of the plurality of threshold values;
apply an indicator to the vector; and
diagnose a shared bus based on the indicator.

13. The apparatus of claim 12, wherein the indicator is a settled state indicator; and
the control circuit diagnoses the shared bus by:
comparing a predetermined sample of the vector to a pre-defined amplitude range;
determining that the shared bus is terminated when the predetermined sample of the vector is within the pre-defined amplitude range;
determining that the shared bus is shorted when the predetermined sample of the vector is below the pre-defined amplitude range; and
determining that the shared bus is open when the predetermined sample of the vector is above the pre-defined amplitude range.

14. The apparatus of claim 12, wherein the indicator is a significant slope indicator; and
the control circuit diagnoses the shared bus by:
determining whether a slope of the vector has multiple portions above a predetermined threshold;
determining that the shared bus is terminated when the slope of the vector has one portion above the predetermined threshold;
determining that the shared bus is short when the slope of the vector has two portions above the predetermined threshold, a slope of a first portion above the predetermined threshold is positive and a slope of a second portion above the predetermined threshold is negative; and
determining that the shared bus is open when the slope of the vector has two portions above the predetermined threshold, a slope of a first portion above the predetermined threshold is positive and a slope of a second portion above the predetermined threshold is positive.

15. The apparatus of claim 12, wherein the indicator is a maximum amplitude indicator; and
the control circuit diagnoses the shared bus by determining whether a plurality of consecutive samples of the vector are beyond a predetermined maximum amplitude.

16. The apparatus of claim 12, wherein the indicator is a voltage sum indicator; and
the control circuit diagnoses the shared bus by summing a plurality of threshold codes the vector over time and comparing the sum to a predetermined threshold.

17. The apparatus of claim 12, wherein the indicator is a gradient indicator; and
the control circuit diagnoses the shared bus by analyzing a slope of a droop of the vector to determine whether the slope of the droop exceeds a predetermined threshold.

18. The apparatus of claim 12, wherein the indicator is a localized slope indicator; and
the control circuit diagnoses the shared bus by analyzing a slope of the vector at a predetermined location to determine whether the slope exceeds a predetermined threshold.

19. A system comprising:
a shared bus;
a transceiver coupled to the shared bus, the transceiver to:
transmit a pulse signal over a shared bus;
capture an observed signal, wherein the observed signal is a superimposition of the pulse signal and a reflection signal;
compare an amplitude of the observed signal to a plurality of threshold values; and
output a sequence of bits indicative of an amplitude of an observed signal compared to a plurality of threshold values at a given sampling time; and
a control circuit coupled to the transceiver, the control circuit to:
receive a plurality of sequences of bits, wherein a given one of the plurality of sequences of bits is indicative of an amplitude of the observed signal compared to a given one of a plurality of threshold values at a plurality of sampling times;
creating a vector based on the plurality of sequences of bits, wherein the vector indicates, for a given one of the plurality of sampling times, a first threshold of the plurality of threshold values at which the amplitude of the observed signal exceeds one of the plurality of threshold values;
apply an indicator to the vector; and
diagnose a shared bus based on the indicator.

20. The system of claim 19, wherein the indicator is a settled state indicator, a significant slope indicator, a maximum amplitude indicator, a voltage sum indicator, a gradient indicator, or a localized slope indicator.
